(19) United States
(12) Patent Application Publication
(10) Pub. No.: US 2022/0398455 A1
(43) Pub. Date: Dec. 15, 2022

(54) ITERATIVE TRAINING OF NEURAL NETWORKS FOR INTRA PREDICTION

(71) Applicant: INTERDIGITAL VC HOLDINGS FRANCE, SAS, Cesson Sevigne (FR)

(72) Inventors: Thierry DUMAS, Rennes (FR); Franck GALPIN, Thorigne-Fouillard (FR); Philippe BORDES, Laille (FR)

(21) Appl. No.: 17/774,497

(22) PCT Filed: Nov. 3, 2020
(86) PCT No.: PCT/EP2020/080725

§ 371 Date: May 5, 2022

(30) Foreign Application Priority Data
Nov. 7, 2019 (EP) 19306442.5
Jan. 13, 2020 (EP) 20290006.4

(51) Int. Cl. G06N 3/08; H04N 19/436; H04N 19/176; H04N 19/593; H04N 19/192; H04N 19/105; H04N 19/11; G06N 3/04

(52) U.S. Cl. CPC G06N 3/08; H04N 19/436; H04N 19/176; H04N 19/593; H04N 19/192; H04N 19/105; H04N 19/11; G06N 3/0454; H04N 19/124

(57) ABSTRACT

An iterative training of neural networks for video coding and decoding using intra prediction is provided that finds a tradeoff between an extreme genericity and an extreme specialization to a codec for the trained neural networks. At the first iteration, the set of neural networks is trained following a partitioning approach. Then, for several iterations, the set of neural networks is inserted into the codec, and pairs of a block and its context are extracted from the partitioning of images via the codec with a single additional neural network-based mode then, the neural networks are retrained on these pairs. This way, from the second iteration, the neural networks learn an intra prediction diverging from that in the codec while still being valuable for the codec in terms of rate-distortion performance.

### TECHNICAL FIELD

At least one of the present embodiments generally relates to a method or an apparatus for video encoding or decoding, compression or decompression.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

At least one of the present embodiments generally relates to a method or an apparatus for video encoding or decoding, and more particularly, to a method or an apparatus for simplifications of coding modes based on neighboring samples dependent parametric models.

According to a first aspect, there is provided a method. The method comprises steps for training a set of neural networks for intra prediction of a video block using pairs of partitioned portions of said video block and surrounding regions; extracting further pairs of said video block and surrounding regions by iteratively using said set of neural networks as an additional intra coding mode for a codec; and, retraining said set of neural networks using said extracted further pairs to generate a set of neural networks for intra prediction.

According to a first aspect, there is provided a method. The method comprises steps for the aforementioned training of a set of neural networks for intra prediction and further comprises performing encoding or decoding of a video block using the generated set of neural networks.

According to another aspect, there is provided an apparatus. The apparatus comprises a processor. The processor can be configured to encode a block of a video or decode a bitstream by executing any of the aforementioned methods.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of a video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 shows reference samples for intra prediction in H.266 in the case of a square current block.

FIG. 2 shows directions of intra prediction for square blocks in H.266.

FIG. 3 shows above and left CU locations for deriving the MPM list in for different block shapes

FIG. 4 shows decision tree illustrating the intra prediction signaling for luma in VTM-6.0.

FIG. 5 shows an example decision tree illustrating the intra prediction signaling for chroma in VTM-6.0.

FIG. 6 shows an example of context surrounding the current square block to be predicted.

FIG. 7 shows an example of intra prediction of a square block from its context via a fully-connected neural network

FIG. 8 shows an example of intra prediction of a square block from its context via a convolutional neural network.

FIG. 9 shows an extraction of a W×W block Y from the original image I and its context X from the reconstruction of I via H.265.

FIG. 10 shows another extraction of a W×W block Y from the original image I and its context X from the reconstruction of I via H.265.

FIG. 11 shows an example of extraction via “extract_pair” of a W×W block Y from the original image I and its context X from the reconstruction of I via H.265.

FIG. 12 shows an example of extraction via “extract_pair” of a H×W block Y from the original image I and its context X from the reconstruction of I via H.266.

FIG. 13 shows an example of extraction via “extract_pair” of a H×W block Y and its context X from the original image I at the spatial location x, y given by the image partitioning, H.266 being used.

FIG. 14 shows a standard, generic video compression scheme.

FIG. 15 shows a standard, generic video decompression scheme.

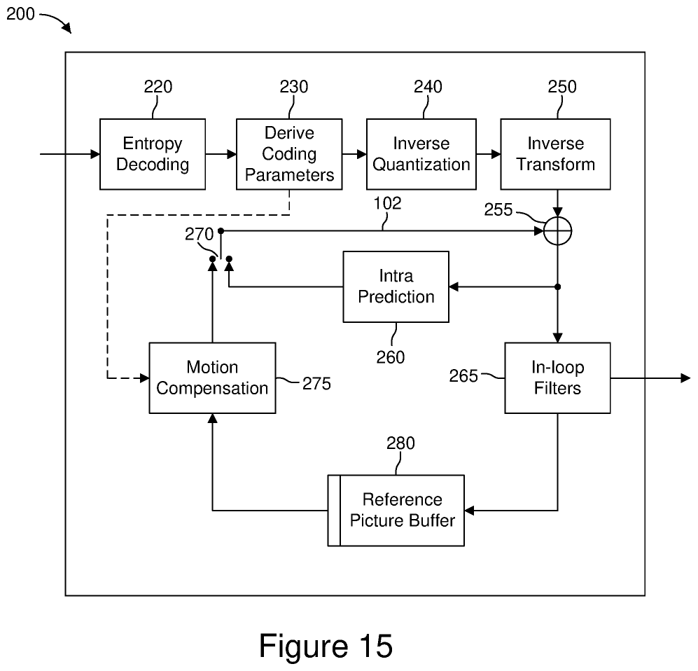

FIG. 16 shows a processor based system for encoding/decoding under the general described aspects.

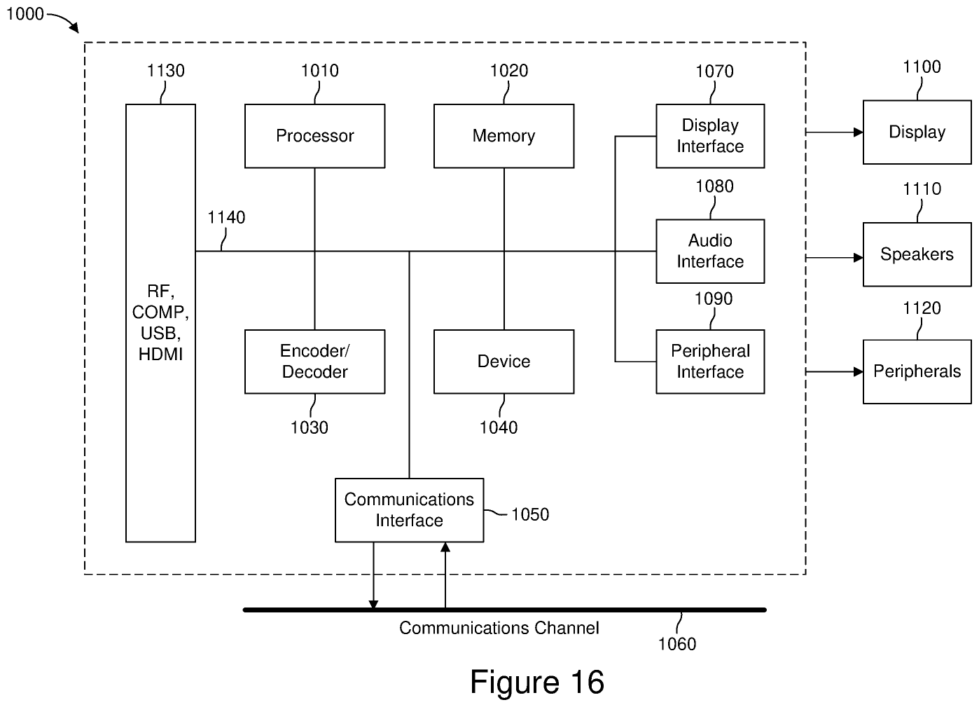

FIG. 17 shows one embodiment of a method under the general described aspects.

FIG. 18 shows another embodiment of a method under the general described aspects.

FIG. 19 shows an example apparatus under the described aspects.

### DETAILED DESCRIPTION

Intra prediction is a core coding tool in all video compression standards such as H.264/AVC, HEVC, and VVC. The basic idea is to exploit the spatial correlation in an image frame sequence by predicting a block of pixels based on already decoded causal neighbor pixels. The prediction residual at the encoder is subsequently transformed with a block transform, the transform coefficients are quantized and then binary encoded. At the decoder, the block is reconstructed by adding the prediction to the decoded residual, which results from the inverse process of binary decoding, de-quantization, and inverse transform.

For prediction purposes, the standards define several models known as prediction modes. HEVC, for example, defines 35 prediction modes where one is a PLANAR mode, one is a DC mode, and the remaining 33 are angular modes. The PLANAR and DC modes aim to model slow and gradually changing intensity regions whereas the angular modes aim to model different object directionalities. VVC, on the other hand, defines 67 regular intra prediction modes, which include the 35 prediction modes from HEVC and an additional 32 angular modes. VVC also defines 28 wide angular modes to be used with rectangular coding blocks. The encoder prediction tool selects the best prediction mode in the sense of rate-distortion performance and signals it to the decoder using a mode coding scheme. The decoder prediction tool decodes the prediction mode and predicts the current block with this mode using the decoded pixels from neighbor pixels.

The general aspects described herein address the problem of training neural networks for intra prediction in video codecs such as H.265/HEVC and H.266/VVC. The term “context” is used to refer to the neighboring region of a block fed into a neural network, comprising several rows of decoded pixels above the block and several columns of pixels on the left side of the block. In contrast, the term “reference samples” is always used to refer to the neighboring region of this block fed into an intra prediction mode in H.265/H.266, comprising a row of decoded pixels above the block and a column of decoded pixels on the left side of the block.

A neural network for intra prediction infers from the context, or neighboring region, surrounding the current block to be predicted a prediction of this block. A set of trained neural networks forms a single additional intra prediction mode in the video codec of interest. In this additional single mode, each neural network predicts blocks of a different size.

There exist two ways of training the neural networks in this set. The first way consists in extracting from YC_{b}Cᵣ images and their reconstruction via the codec pairs of a block and its context at random spatial locations, then training the neural networks on these pairs. More precisely, a block is extracted from a YC_{b}Cᵣ image at a random spatial location and its context is extracted from the reconstruction of this image via the codec at the same spatial location. But the trained neural networks tend to provide blurry predictions as they are trained on an unrestricted variety of pairs of a block and its context. The trained neural networks are said to be too “generic”. In the second way, pairs of a block and its context are extracted from the partitioning of YC_{b}Cᵣ images via the codec of interest, then the neural networks are trained on these pairs. More precisely, each block returned by the partitioning of a YC_{b}Cᵣ image via the codec is collected, and its context is extracting from the reconstruction of this image. However, the trained neural networks mainly learn the intra prediction of the codec as the partitioning mechanism ensures that each returned block is relatively well predicted by an intra prediction mode in the codec from its set of reconstructed reference samples. This time, the trained neural networks are said to “specialize” too much to the video codec.

To find a tradeoff between an extreme genericity and an extreme specialization to the codec for the trained neural networks, an iterative training of neural networks for intra prediction is proposed. At the first iteration, the set of neural networks is trained following the above-mentioned second way. Then, for several iterations, (i) the set of neural networks is inserted into the codec, and pairs of a block and its context are extracted from the partitioning of YC_{b}Cᵣ images via the codec with the single additional neural network-based mode, (ii) the neural networks are retrained on these pairs. This way, from the second iteration, the neural networks learn an intra prediction diverging from that in the codec while still being valuable for the codec in terms of rate-distortion performance.

This section introduces the intra prediction component of video codecs. It focuses on the video codec H.266 as it is currently viewed as the best video codec in terms of compression performance and it is an extension of H.265. Then, the intra prediction based on neural networks is presented, along with two approaches from the literature for training the neural networks.

The intra prediction process in H.266 consists of gathering reference samples, processing them, deriving the actual prediction of the samples of the current block, and finally post-processing the predicted samples.

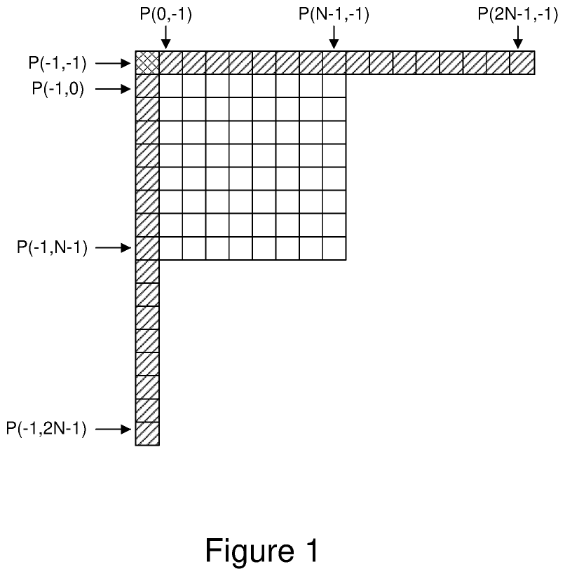

The reference sample generation process is illustrated in FIG. 1. An “above” row of 2 W samples is formed from the previously reconstructed pixels located above the current block, W denoting the block width. Similarly, a “left” column of 2H samples is formed from the reconstructed pixels located on the left side of the current block, H denoting the block height. The corner pixel is also used to fill up the gap between the “above” row and the “left” column references. If some of the samples above the current block and/or on its left side are not available, because of the corresponding Coding Blocks (CBs) not being in the same slice or the current CB being at a frame boundary, then a method called reference sample substitution is performed where the missing samples are copied from the available samples in a clock-wise direction. Then, depending on the current CU size and the prediction mode, the reference samples are filtered using a specified filter.

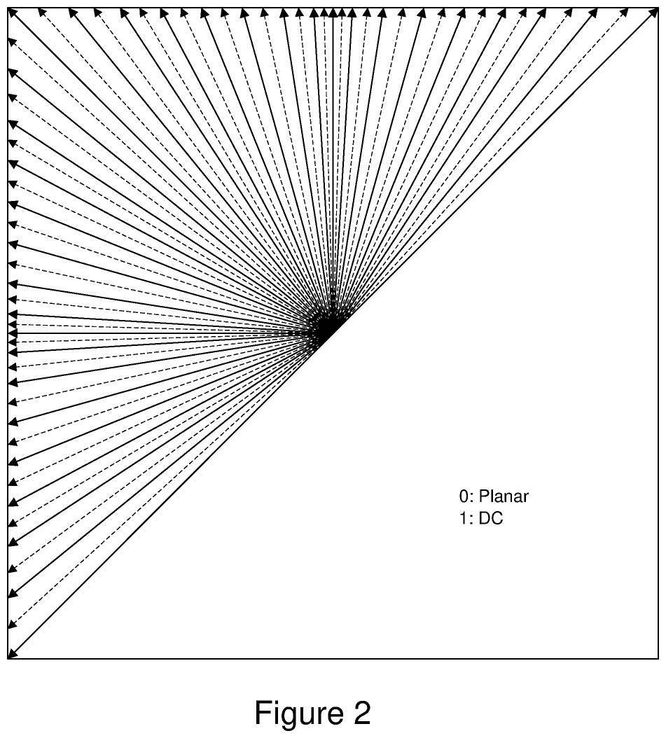

H.266 includes a range of prediction models derived from those in H.265. Planar and DC prediction modes are used to predict smooth and gradually changing regions, whereas angular prediction modes are used to capture different directional structures. There exist 65 directional prediction modes which are organized differently for each rectangular block shape. These prediction modes correspond to different prediction directions as illustrated in FIG. 2.

The intra prediction was further expanded with tools such as intra prediction with Multiple Reference Lines (MRL), Intra prediction with Sub-Partitions (ISP), and Matrix Intra-prediction (MIP). MIP is a set of intra prediction modes, each inferring a prediction of the current block from reconstructed pixels via an affine transformation [4]. For 4×4 blocks, there exist 35 modes. For 4×8, 8×4, and 8×8 blocks, there are 19 modes. For the other blocks, 11 modes are used.

### Intra Prediction Signaling for Luma

The following paragraph focuses on the signaling of planar, DC, and the 65 directional modes, omitting the signaling of MRL, that of ISP, and that of MIP. These last three will be detailed in the subsequent paragraphs.

### Signaling of Planar, DC, and the 65 Directional Modes

On the encoder side, the best intra prediction mode according to a rate-distortion criterion is selected, and its index is transmitted from the encoder to the decoder. To perform the signaling of the selected mode index via entropy coding, a list of Most Probable Modes (MPMs) is built.

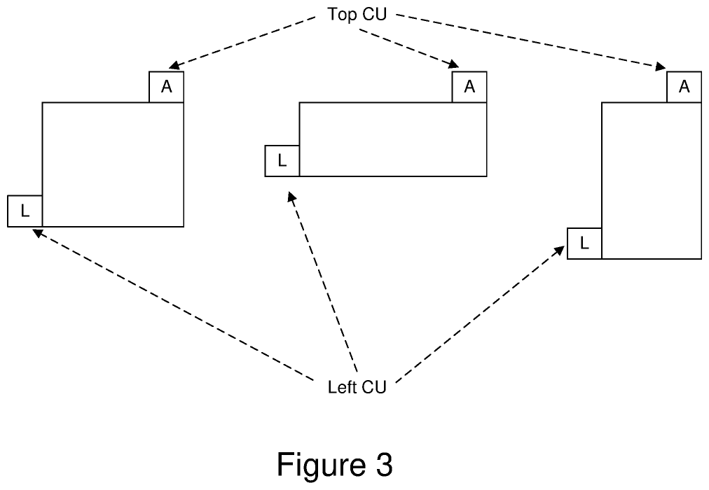

In VTM-6.0, an MPM list contains 6 intra prediction modes for signaling the intra prediction mode of the current block. The MPM list is created from the prediction modes of the intra coded CUs located above and on the left side of the current CU and some default modes. The above and left CUs are at the right and bottom edge of the current block, as shown in FIG. 3.

```
L ≡ prediction mode of the left CU (value in range [0-66])
A ≡ prediction mode of the above CU (value in rage [0-66])
offset = 61
mod = 64
Initialization of the MPM list:
MPM[0] = PLANAR_IDX
MPM[1] = DC_IDX
MPM[2] =VER_IDX
MPM[3] = HOR_IDX
MPM[4] = VER_IDX − 4
MPM[5] = VER_IDX + 4
if(L = A)
  if (L> DC_IDX)
    MPM[0] = PLANAR_IDX
    MPM[1] = L
    MPM[2] = ((L + offset) % mod) + 2
    MPM[3] = ((L− 1) % mod) + 2
    MPM[4] = DC_IDX
    MPM[5] = ((L + offset − 1) % mod) + 2
  else
    use initialized values
else
  if ((L > DC_IDX) && (A > DC_IDX))
    MPM[0] = PLANAR_IDX
    MPM[1] = L
    MPM[2] = A
    MPM[3] = DC_IDX
    MPM[4] = ((max(L,A) + offset) % mod) + 2 if L and A are not adjacent
      = ((max(L,A) + offset − 1) % mod) + 2, otherwise
    MPM[5] = ((max(L,A) − 1) % mod) + 2 if L and A are not adjacent
      = ((max(L,A) - 0) % mod) + 2 otherwise
  else if (L + A >= 2)
    MPM[0] = PLANAR_IDX
    MPM[1] = max(L,A)
    MPM[2] = DC_IDX
    MPM[3] = ((max(L,A) + offset) % mod) + 2
    MPM[4] = ((max(L,A) − 1) % mod) + 2
    MPM[5] = ((max(L,A) + offset -1) % mod) + 2
  else
    use initialized values
Using circular adjacency over the range [2-66], it can be equivalently written
((L + offset) % mod) + 2 = L - 1
((L + offset - 1) % mod) + 2 = L - 2
((L − 1) % mod) + 2 = L + l
((L − 0) % mod) + 2 = L + 2
```

Using the above relationships, it can be shown that the MPM list derivation is that in Table 1.

TABLE 1
MPM derivation in VTM-6.0. A and L denote the predictions modes of above and left CUs respectively.

| Conditions | | | MPM[0] | MPM[1] | MPM[2] | MPM[3] | MPM[4] | MPM[5] |
|---|---|---|---|---|---|---|---|---|
| L = A | L ≠ PLANAR_IDX and | | PLANAR_IDX | L | L − 1 | L + 1 | DC_IDX | L-2 |
| | L ≠ DC IDX | | | | | | | |
| | otherwise | | PLANAR_IDX | DC_IDX | VER_IDX | HOR_IDX | VER_IDX-4 | VER_IDX + 4 |
| L ≠ A | L > DC_IDX and A > DC_IDX | | PLANAR_IDX | L | A | DC_IDX | max(L,A) − | max(L,A) + |
| | | | | | | | 2, if L and | 2, if L and |
| | | | | | | | A are | A are |
| | | | | | | | adjacent | adjacent |
| | | | | | | | else | else |
| | | | | | | | max(L,A) − 1 | max(L,A) + 1 |
| | otherwise | L + A >= 2 | PLANAR_IDX | max(L,A) | DC_IDX | max(L,A) − | max(L,A) + 1 | max(L,A) − |
| | | | | | | 1 | | 2 |
| | | otherwise | PLANAR_IDX | DC_IDX | VER_IDX | HOR_IDX | VER_IDX-4 | VER_IDX + 4 |

If the selected intra prediction mode for predicting the current block corresponds to one of the six MPM modes, this is signaled via the mpmFlag with value 1 and then by signaling the candidate mode from the MPM list using the variable length coding scheme shown in Table 2. Otherwise, the mpmFlag is equal to 0 and the candidate index in the set of remaining 61 modes is truncated binary encoded with either 5 or 6 bits.

TABLE 2
MPM signaling in VTM-6.0.

| Candidate Index | Code |
|---|---|
| MPM[0] | 0 |
| MPM[1] | 10 |
| MPM[2] | 110 |
| MPM[3] | 1110 |
| MPM[4] | 11110 |
| MPM[5] | 11111 |

### Signaling of Multiple Reference Lines (MRL)

For intra prediction with MRL, the reference line used for the prediction is signaled with a flag multiRefIdx. The valid values of multiRefIdx are 0, 1, and 3, which signal the first, the second, and the fourth reference line respectively. When multiRefIdx is non-zero, meaning either the second or the fourth reference line is used, the prediction mode always belongs to the MPM list. Thus, the mpmFlag is not signaled. Furthermore, planar is excluded from the list. This means that, when multiRefIdx is non-zero, only five prediction modes are available as possible candidates. When multiRefIdx is non-zero, the prediction mode is signaled as shown in Table 3.

TABLE 3
MPM signaling when multiRefIdx > 0 in VTM-6.0.

| Candidate index | Code |
|---|---|
| MPM[1] | 0 |
| MPM[2] | 10 |
| MPM[3] | 110 |
| MPM[4] | 1110 |
| MPM[5] | 1111 |

Signaling of Intra Prediction with Sub-Partitions (ISP)

For ISP, the type of partitioning used for the CU is signaled with a flag called ispMode. ispMode is encoded only when multiRefIdx is equal to 0. The valid values of ispMode are 0, 1, and 2, which signal no partitioning, horizontal partitioning, and vertical partitioning respectively.

### Signaling of Matrix Intra Prediction (MIP)

An MIP mode is first signaled with a flag called mipFlag, a value of 1 meaning that a MIP mode is used for predicting the current block, and 0 meaning that one of the 67 intra prediction modes is used. When mipFlag is equal to 1, multiRefIdx is necessarily equal to 0, meaning that the first reference line is used, and ispMode is equal to 0, i.e. there is no target CU partition. Therefore, when mipFlag is equal to 1, multiRefIdx and ispMode are not written to the bitstream. If mipFlag is equal to 1, the index of the selected MIP mode is then truncated binary encoded since VTM-6.0.

To handle the case where the intra prediction mode for predicting the current block is one of the 67 intra prediction modes and the selected mode for predicting the above CU or the one for predicting the left CU is a MIP mode, a mapping between each MIP mode and one of the conventional modes enables to substitute this MIP mode with its mapped conventional mode. Since VTM-6.0, any MIP mode is mapped to planar.

### Summary of the Intra Prediction Signaling for Luma

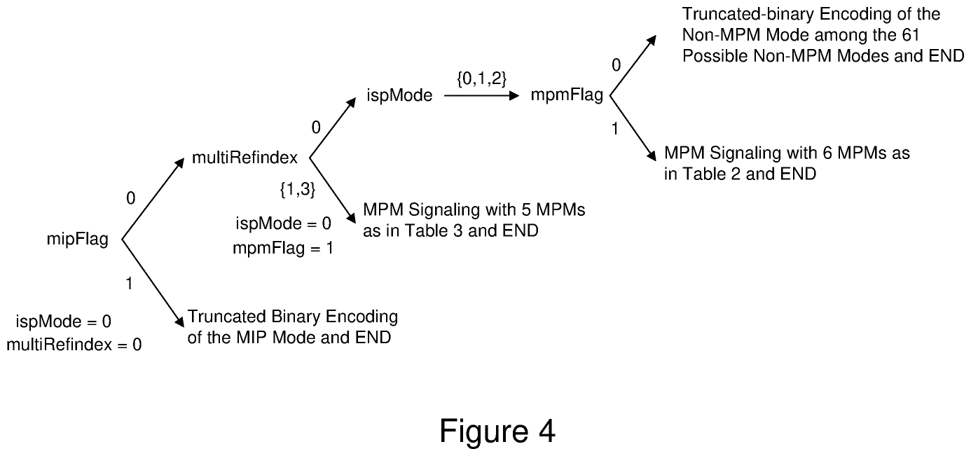

The intra prediction signaling for luma is summarized via a decision tree in FIG. 4. In FIG. 4, a flag in light gray indicates that the value of the flag is deduced from the value of the previous flags written to the bitstream on the encoder side and read from the bitstream on the decoder side. This means that the flags in light gray are not written to the bitstream on the encoder side; they are not read from the bitstream on the decoder side.

### Intra Prediction Signaling for Chroma

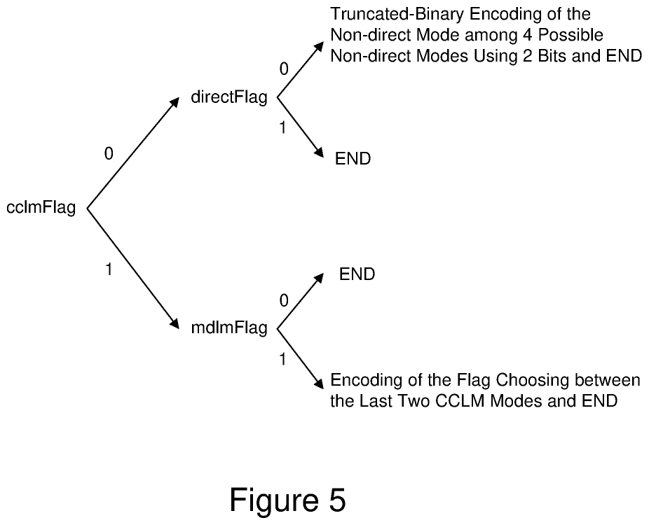

For the two chroma channels, neither MRL nor ISP nor MIP is used. However, two specific tools are used: the direct mode and Cross-Component Linear Model (CCLM). The direct mode corresponds to the application of the selected mode for predicting the collocated luma block to the prediction of the current chroma block. If the directFlag is equal to 1, the direct mode is selected for predicting the current chroma block. Otherwise, the directFlag is equal to 0, and one mode in the list L=[planar, vertical, horizontal, DC] is selected. If a mode in L is equal to the direct mode, this mode is replaced by the mode of index 66. In CCLM, a linear model predicts the current chroma block from the reconstructed luma reference samples surrounding the collocated luma block. The parameters of the linear model are derived from the reconstructed reference samples. There exist three CCLM modes, each associated to a different derivation of the parameters. If the cclmFlag is equal to 1, one of the three CCLM mode is selected. In this case, the directFlag is not written to the bitstream. Otherwise, the cclmFlag is equal to 0, and either the direct mode or one of the modes in L is selected. The intra prediction signaling for chroma is represented in FIG. 5.

### Neural Network-Based Intra Prediction

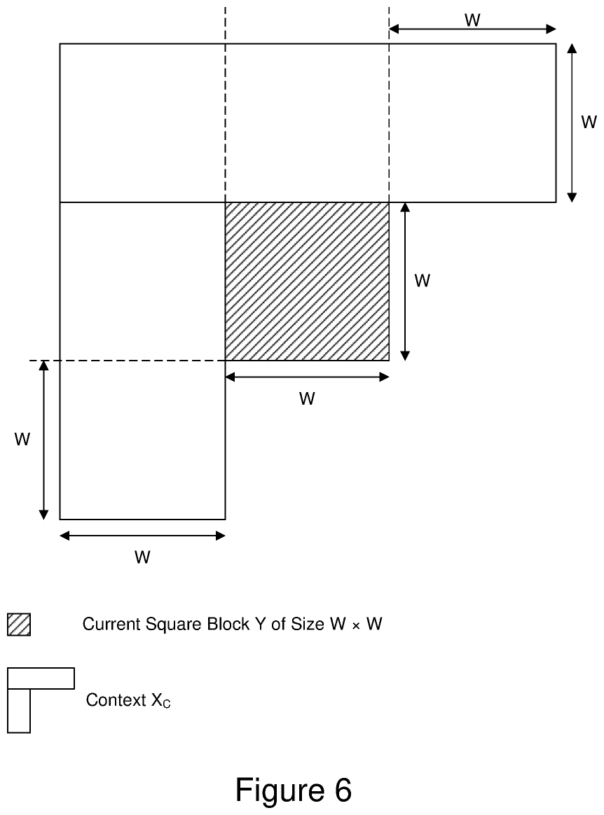

A neural network for intra prediction infers from the context surrounding the current block to be predicted a prediction of this block. The context X, is composed of reconstructed pixels located above the current block Y and on its left side, similarly to the set of reconstructed reference samples for the intra prediction in H.266. But, unlike it, the context X, is extended towards the left and the top, see FIG. 6. Thanks to this extension, the neural network can learn a relationship between the spatial correlations in its input context and the prediction it gives. Note that the subscript “c” in X, indicates that the reconstructed pixels in the context have already been preprocessed, as detailed in the section “Signaling the neural network-based intra prediction mode inside a video codec”.

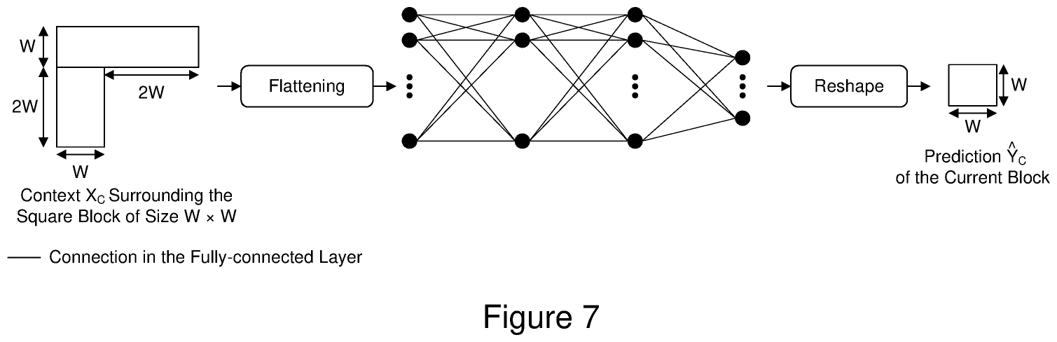

If the neural network is fully-connected, the context is typically flattened into a vector, and the resulting vector is fed into the neural network. Then, the vector provided by the neural network is reshaped to the shape of the current block, yielding the prediction Ŷ_{c}, see FIG. 7. Note that the subscript “c” in Ŷ_{c} indicates that the predicted pixels have not been post-processed yet, which is explained in the section “Signaling the neural network-based intra prediction mode inside a video codec”.

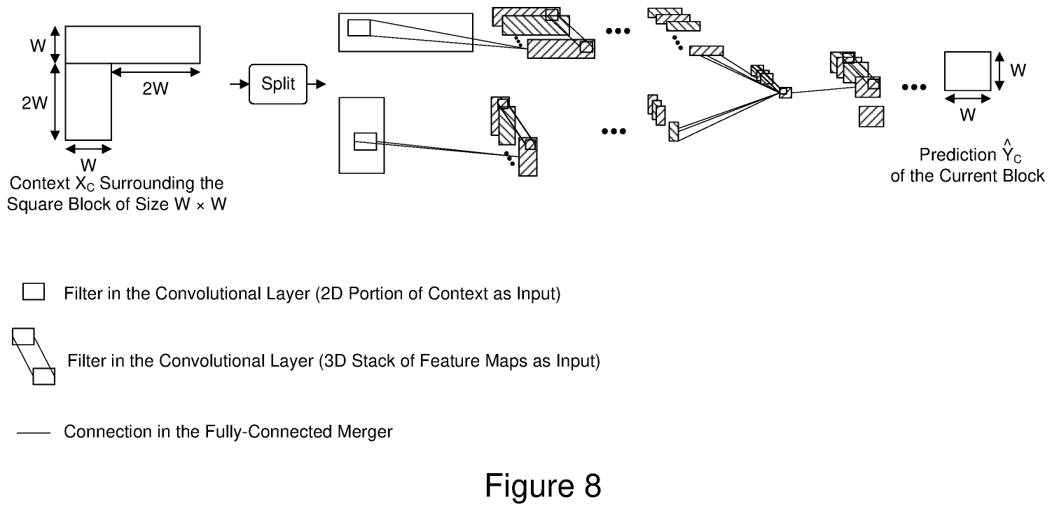

If the neural network is convolutional, the context can be split into two portions. Then, each portion is fed into a stack of convolutional layers. The two stacks of feature maps at the output of the two stacks of convolutional layers are merged via full connectivity. Finally, the result of the merge is inserted into a stack of transpose convolutional layers, yielding the prediction Ŷ_{c} see FIG. 8.

### Creating a Neural Network-Based Intra Prediction Mode Inside a Video Codec

In H.265 and H.266, the image is split into Coding Tree Units (CTUs). A CTU contains a luminance Coding Tree Block (CTB), two chrominance CTBs, and syntax elements. From now on, the focus is on the luminance CTBs for simplification. The CTBs are processed one at a time, in raster-scan order. Each CTB can be split hierarchically into Coding Blocks (CBs). The CBs in a CTB are processed in Z-scan order. In H.265 for instance, the size of a block to be predicted can be either 64×64, 32×32, 16×16, 8×8 or 4×4. This means that 5 neural networks are needed, one for each size of block to be predicted. The neural network-based intra prediction mode is thus made of the 5 neural networks. In H.266, as the hierarchical splitting is more sophisticated, a block to be predicted can be of size either 128×128, 64×64, 32×32, 16×16, 8×8 or 4×4. Besides, it can also be rectangular, e.g. of size 4×8. In this case, a solution is to assign one neural network per block size to build the neural network-based mode.

### Signaling the Neural Network-Based Intra Prediction Mode Inside a Video Codec

In the different works integrating a neural network-based intra prediction mode into a video codec [1, 2, 3], usually H.265, the neural network-based mode is systematically in competition with the existing ones. For the current block to be predicted, a flag is written to the bitstream before all the other flags for intra prediction. The value 1 indicates that the neural network-based intra prediction mode is selected for predicting the current block. In this case, no other flag for intra prediction is written to the bitstream. The value 0 means that one of the regular intra prediction is selected. In this case, the regular flags for intra prediction are then written to the bitstream.

Note that, the above-mentioned signaling has been implemented in H.265. No approach has been proposed yet in H.266. Notably, it is not clear yet how to handle the flags mipFlag, multiRefIdx, and ispMode when the neural network-based mode is selected.

### Training the Neural Networks for Intra Prediction

In the literature, there exist two main ways of training neural networks for intra prediction. The two ways, called training via “random” data extraction and training via “partitioning” data extraction, are described in the following two sections.

### Training Via “Random” Data Extraction

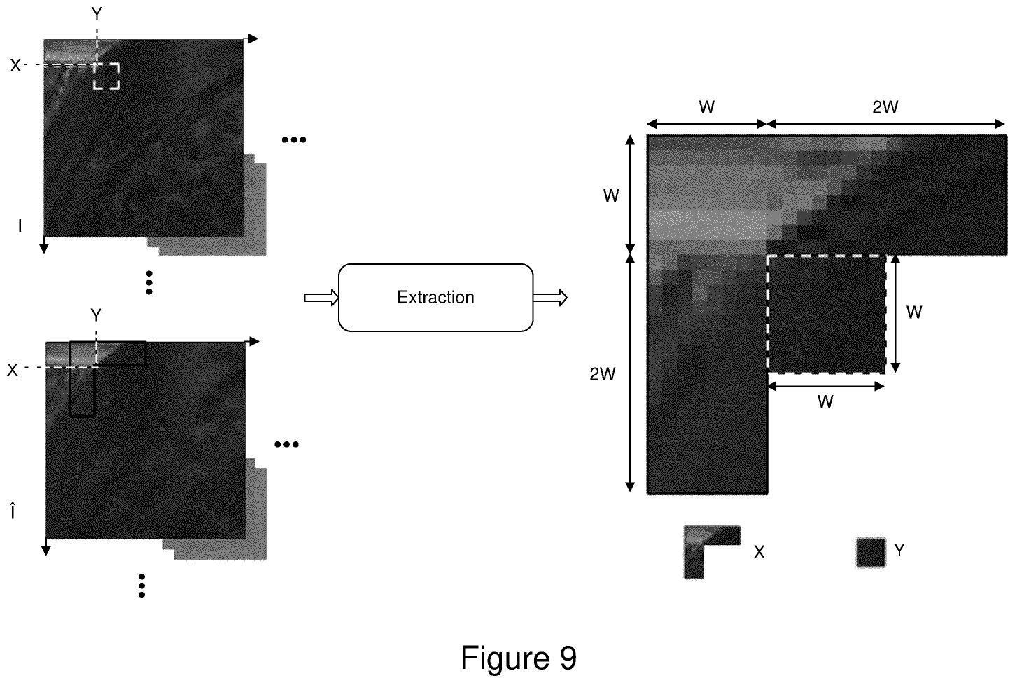

In the first way of training neural networks for intra prediction, pairs of a block and its context are extracted from YC_{b}Cᵣ images and their reconstruction via the codec of interest at random spatial locations, then the neural networks are trained on these pairs. More specifically, let us take the example of the training of the neural network for predicting W×W blocks. For each image I in a set of YC_{b}Cᵣ images, this image is encoded via the codec of interest and, several times, (i) a W×W block Y is extracted from I at a random spatial location (x, y), see FIG. 9, (ii) its context X is extracted from the reconstruction Î of I at (x, y), (iii) the block and its context are preprocessed and added to the training set of the neural network for predicting W×W blocks. FIG. 9 shows extraction of a W×W block Y from the original image I and its context X from the reconstruction Î of I via H.265 with Quantization Parameter (QP) of 37 at the same random spatial location x, y. Here, the image is in 4:2:0, W=8, x=8, and y=16. Note that the pair x, y corresponds to the position of the pixel at the top-left of Y in I.

However, using the training via “random” data extraction, the trained neural networks usually provide blurry predictions as they are trained on an unrestricted variety of pairs of a block and its context, usually in which many predictions of a block are likely given its context.

### Training Via “Partitioning” Data Extraction

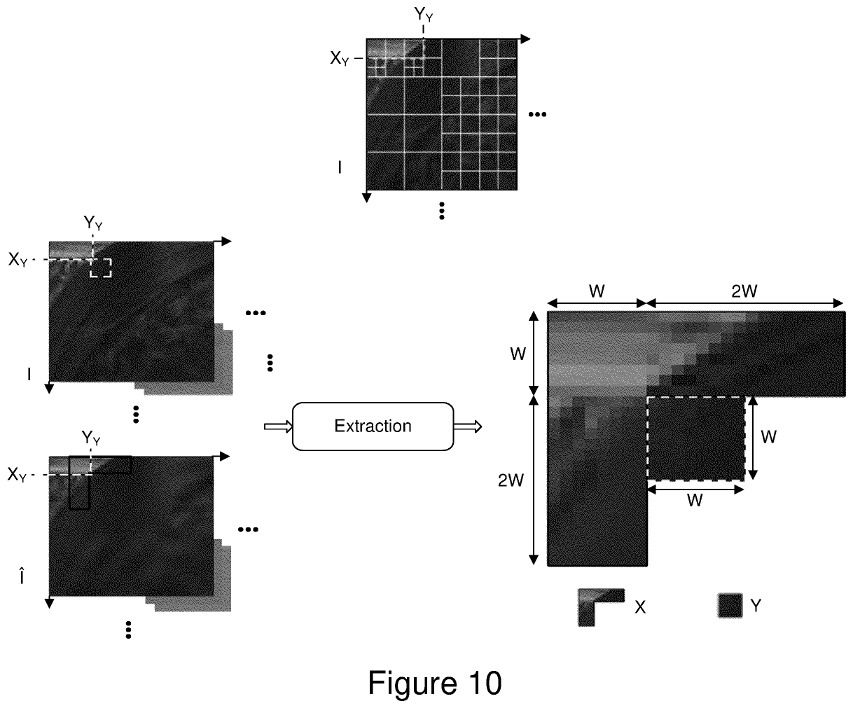

In the second way of training neural networks for intra prediction, pairs of a block and its context are extracted from the partitioning of YC_{b}Cᵣ images via the codec, then the neural networks are trained on these pairs. Again, we will focus on the example of the training of the neural network for predicting W×W blocks. For each image I in a set of YC_{b}Cᵣ images, this image is encoded via the codec of interest and, for each W×W block Y returned by the image partitioning, (i) Y is extracted from I at the spatial location (x_{y}, y_{y}) given by the image partitioning, see FIG. 10, (ii) its context X is extracted from the reconstruction Î of I at (x_{y}, y_{y}), (iii) the block and its context are preprocessed and added to the training set of the neural network for predicting W×W blocks. FIG. 10 shows extraction of a W×W block Y from the original image I and its context X from the reconstruction of I via H.265 with QP of 37 at the spatial location xY, yY given by the image partitioning. Here, the image is in 4:2:0, W=8, xY=8, yY=24. Note that the pair xY, yY corresponds to the position of the pixel at the top-left of Y in I.

But, using the training via “partitioning” data extraction, the trained neural networks mainly learn the intra prediction of the codec of interest.

The described aspects aim at training the neural networks for intra prediction such that they learn an intra prediction diverging from that in the codec of interest while still being valuable for the codec in terms of rate-distortion performance. The set of neural networks is trained outside an encoder and a decoder. There can be a unique set of neural networks and the set is trained before the actual encoding and decoding. The same set of trained neural network is then put into both the encoder and the decoder. A decoder does not need information to tell it to select a set of neural networks. Then, the actual encoding and decoding can start.

### Iterative Training of Neural Networks for Intra Prediction

The first thrust of the described aspects is to avoid the case where a learned model gives blurry predictions because it was trained on an unrestricted variety of pairs of a block and its context. That is why a set Γ of YC_{b}Cᵣ images is encoded via the codec to yield the training sets

$${\{ {S}_{H , W} \}}_{H ϵ {R}_{H} , W ∈ {R}_{W}} ,$$

where S_{H,W} contains pairs of a block of size H×W provided by the partitioning of an image in Γ and its context. Then, each neural network f_{H,W}(.; θ_{H,W}), parametrized by θ_{H,W}, is trained on S_{H,W}, see Method 1. R_{H} is the set of all possible block heights in the codec whereas R_{W} is the set of all possible block widths in the codec.

It is essential to note that the image partitioning in the codec of interest returns Transform Blocks (TBs). Inside the codec, there may exist a Coding Block (CB) size that is not a TB size as a CB of this size is forced to be split. The single additional neural network-based intra prediction mode in the codec has a neural network dedicated to the prediction of CBs of this size. Thus, the neural network for predicting CBs of this size must be trained but its training set cannot be generated via the method described in the previous paragraph. Instead, the training via “random” data extraction explained in the section “Training via “random” data extraction” can be used for training this neural network. As an example, in H.265, H=W as a block is square and W∈R_{W}={4, 8, 16, 32}. Indeed, the largest CB size of 64×64 is not a TB size as a 64×64 CB is forced to be split during an image partitioning.

### Method 1: Iterative Training of Neural Networks for Intra Prediction in the Codec of Interest.

```
Inputs: Γ and l ∈ [symbol] *.
    ${\{ {S}_{H , W} \}}_{H ∈ {R}_{H} , W ∈ {R}_{W}} = extract\_from \_partitioning ( Γ ) , see Method 2 and Method 4.$
  for all H ∈ R_{H}, W ∈ R_{W} do
    ${θ}_{H , W}^{( 0 )} = {min}_{{θ}_{H , W}} {ℒ}_{H , W} ( {S}_{H , W} ; {θ}_{H , W} ) where {θ}_{H , W} is randomly initialized .$
  end for
  for all i ∈ [symbol] 1, l − 1 [symbol]  do
    ${\{ {S}_{H , W} \}}_{H ∈ {R}_{H} , W ∈ {R}_{W}} = extract\_from \_partitioning \_nn ( Γ ; {\{ {θ}_{H , W}^{( i - 1 )} \}}_{H ∈ {R}_{H} , W ∈ {R}_{W}} ) , c . f .$
Method 3 and Method 5.
    for all H ∈ R_{H}, W ∈ R_{W} do
      ${θ}_{H , W}^{( i )} = {min}_{{θ}_{H , W}} {ℒ}_{H , W} ( {S}_{H , W} ; {θ}_{H , W} ) where {θ}_{H , W} = {θ}_{H , W}^{( i - 1 )} at initialization .$
    end for
  end for
$Output : {\{ {θ}_{H , W}^{( l - 1 )} \}}_{H ∈ {R}_{H} , W ∈ {R}_{W}} .$
```

At this stage of the training, the learned models tend to reproduce the intra prediction in the codec of interest. This is due to the fact that the image partitioning generating the training blocks ensures that each training block is relatively well predicted from its set of reconstructed reference samples by an intra prediction mode in this codec. To allow the neural networks to learn an intra prediction progressively diverging from that in the codec while still being valuable for the codec, for l−1 iterations, (i) training sets are built as described in the last paragraph, but replacing the codec by the codec with the single additional neural network-based mode, (ii) the neural networks are retrained on these training sets, see Method 1.

The function that encodes each image in Γ via the codec, then extracts pairs of a block of size H×W provided by the partitioning of this image and its context, H∈R_{H}, W∈R_{W}, called “extract_from_partitioning” in Method 1, depends on the specificities of the codec. Similarly, the function that encodes each image in Γ via the codec with the single additional neural network-based intra prediction mode, then extracts pairs of a block of size H×W provided by the partitioning of this image and its context, H∈R_{H}, W∈R_{W}, called “extract_from_partitioning_nn” in Method 1, depends on the architecture of the codec. That is why “extract_from_partitioning” and “extract_from_partitioning_nn” are presented when applying the iterative training to a specific codec in the following two sections. In Method 1, [symbol] _{H,W} is an objective function to be minimized over the parameters θ_{H,W} of the neural network f_{H,W}(.; θ_{H,W}).

### Iterative Training of Neural Networks for Intra Prediction in H.265

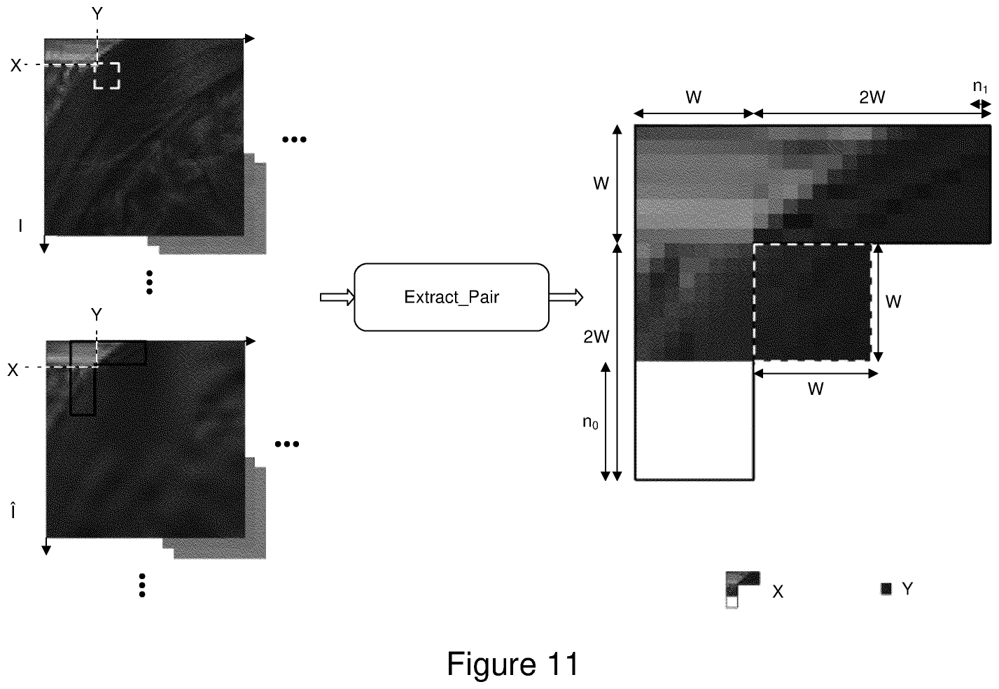

When the codec of interest is H.265, “extract_from_partitioning” can be precisely described, see Method 2. An image I in Γ is encoded via H.265, denoted “h265”, yielding the reconstruction Î of I and a set B of characteristics of blocks from the partitioning of I via H.265. The characteristics of a block gathers the position (x,y) of the pixel at the top-left of the block in I, the block width W, the number n₀ of rows on the bottom-left side of the block that are not reconstructed yet, and the number of columns n₁ on the above-right side of the block that are not reconstructed yet. Note that n₀ and n₁ are useful to fill the pixels in the context of the block that are not reconstructed yet. Then, for each block, its characteristics are used to extract the block Y from I and its context X from Î, see FIG. 11. FIG. 11 shows an example extraction via “extract_pair” of a W×W block Y from the original image I and its context X from the reconstruction I of I via H.265 with QP of 37 at the spatial location x, y given by the image partitioning. The image is in 4:2:0, W=8, x=8, y=16. Here, the n0=8 rows at the bottom-left of the block are not reconstructed yet and all the rows on the above-right side of the block are already reconstructed.

Finally, X and Y are preprocessed via the function “preprocess”, yielding a training pair (X_{c}, Y_{c}) to be added to the training set S_{W}.

### Method 2: “Extract_from_Partitioning” in the Case of H.265

```
Input: Γ and {θ_{W}}_{W∈R}_{_{W}}
    for all W ∈ R_{W} do
      S_{W} = { }
    end for
    for all I ∈ Γ do
      QP ~ [symbol]  {22, 27, 32, 37}
      Î, B = h265_nn(I, QP; {θ_{W}}_{W∈R}_{_{W}})
      for all (x, y, W, n₀, n₁) ∈ B do
        X, Y = extract_pair(I, Î, x, y, W, n₀, n₁), see FIG. 11
        X_{c}, Y_{c} = preprocess(X, Y)
        S_{W}.append((X_{c}, Y_{c}))
      end for
    end for
Output: {S_{W}}_{W∈R}_{_{W}}
```

“extract_from_partitioning_nn” follows the same description as “extract_from_partitioning”, but replacing H.265 by H.265 with the single additional neural network-based intra prediction mode, denoted “h265_nn” in Method 3.

### Method 3: “Extract_from_Partitioning_Nn” in the Case of H.265

```
Input: Γ and {θ_{W}}_{W∈R}_{_{W}}
    for all W ∈ R_{W} do
      S_{W} = { }
    end for
    for all I ∈ Γ do
      QP ~ [symbol]  {22, 27, 32, 37}
      Î, B = h265_nn(I, QP; {θ_{W}}_{W∈R}_{_{W}})
      for all (x, y, W, n₀, n₁) ∈ B do
        X, Y = extract_pair(I, Î, x, y, W, n₀, n₁), see FIG. 11
        X_{c}, Y_{c} = preprocess(X, Y)
        S_{W}.append((X_{c}, Y_{c}))
      end for
    end for
Output: {S_{W}}_{W∈R}_{_{W}}
```

### Iterative Training of Neural Networks for Intra Prediction in H.266

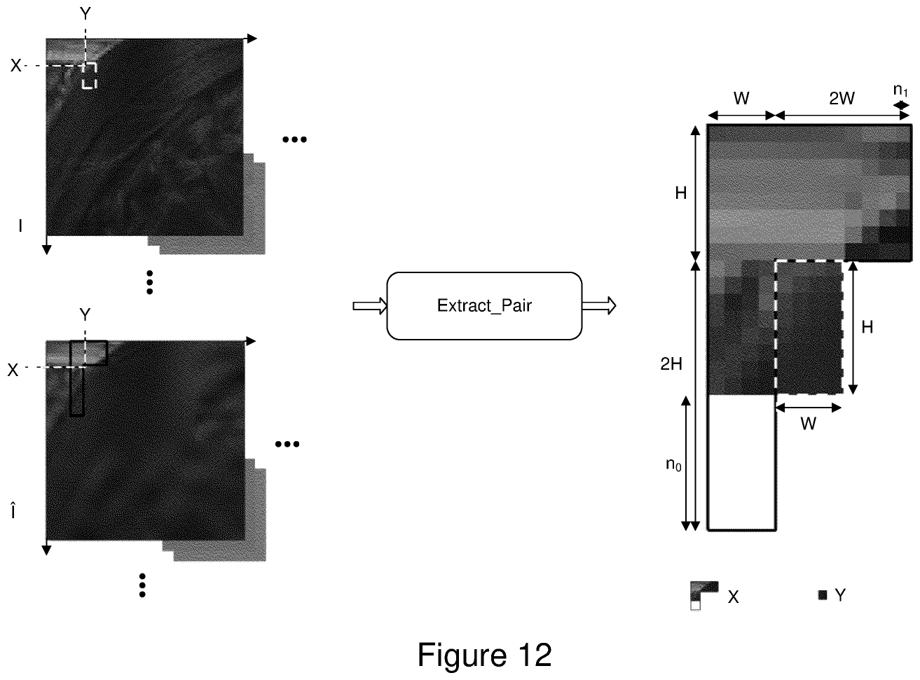

When the codec of interest is H.266, “extract_from_partitioning” shown in Method 2 and “extract_from_partitioning_nn” detailed in Method 3 are modified in two ways. Firstly, a block returned by the partitioning of a YC_{b}Cᵣ image via H.266 can be rectangular. This implies that the block height H is now added to the characteristics of each block in B. Moreover, “extract_pair” is extended to rectangular blocks, see FIG. 12. FIG. 12 extraction via “extract_pair” of a H×W block Y from the original image I and its context X from the reconstruction I of I via H.266 with QP of 37 at the spatial location x, y given by the image partitioning. The image is in 4:2:0, H=8, W=4, x=8, y=16. Here, the n0=8 rows at the bottom-left of the block are not reconstructed yet and all the rows on the above-right side of the block are already reconstructed.

Secondly, H.265 is replaced by H.266, denoted “h266”, and H.265 with the single additional neural network-based intra prediction mode is replaced by H.266 with the single additional neural network-based mode, denoted “h266_nn”, see Method 4 and Method 5.

### Method 4: “Extract_from_Partitioning” in the Case of H.266

```
Input: Γ
  for all H ∈ R_{H}, W ∈ R_{W} do
    S_{H,W} = { }
  end for
  for all I ∈ Γ do
    QP ~ [symbol]  {22, 27, 32, 37}
    Î, B = h266(I, QP)
    for all (x, y, H, W, n₀, n₁) ∈ B do
      X, Y = extract_pair(I, Î, x, y, H, W, n₀, n₁), see FIG. 12.
      X_{c}, Y_{c} = preprocess(X, Y)
      S_{H,W}.append((X_{c},Y_{c}))
    end for
  end for
$Output : {\{ {S}_{H , W} \}}_{H ∈ {R}_{H} , W ∈ {R}_{W}}$
```

### Method 5: “Extract_from_Partitioning_Nn” in the Case of H.266

```
$Input : Γ and {\{ {θ}_{H , W} \}}_{H ∈ {R}_{H} , W ∈ {R}_{W}}$
  for all H ∈ R_{H}, W ∈ R_{W} do
    S_{H,W} = { }
  end for
  for all I ∈ Γ do
    QP ~ [symbol]  {22, 27, 32, 37}
    $\hat{I} , B = h266\_nn ( I , QP ; {\{ {θ}_{H , W} \}}_{H ∈ {R}_{H} , W ∈ {R}_{W}} )$
    for all (x, y, H, W, n₀, n₁) ∈ B do
      X, Y = extract_pair(I, Î, x, y, H, W, n₀, n₁), see FIG. 12.
      X_{c}, Y_{c} = preprocess(X, Y)
      S_{H,W}.append((X_{c},Y_{c}))
    end for
  end for
$Output : {\{ {S}_{H , W} \}}_{H ∈ {R}_{H} , W ∈ {R}_{W}}$
```

### Variants of the Proposed Iterative Training

Any Distribution from which the Quantization Parameter is Drawn

By default, in Method 2, Method 3, Method 4, and Method 5, for a given YC_{b}Cᵣ image I in Γ to be encoded via the codec of interest, the Quantization parameter (QP) for encoding is uniformly drawn from the set {22, 27, 32, 37}. But, the QP could be drawn from any set, not necessarily uniformly.

### Random Initialization of the Neural Networks at Each Iteration of the Training

In Method 1, at the iteration of index i∈ [symbol] 1, l−1 [symbol] , at the beginning of the minimization, the parameters of each neural network are initialized with the neural network parameters obtained at the end of the iteration of index i−1. Alternatively, at the iteration of index i, at the beginning of the minimization, the parameters of each neural network can be randomly initialized.

Extraction of the Context of a Given Block from the Original Image

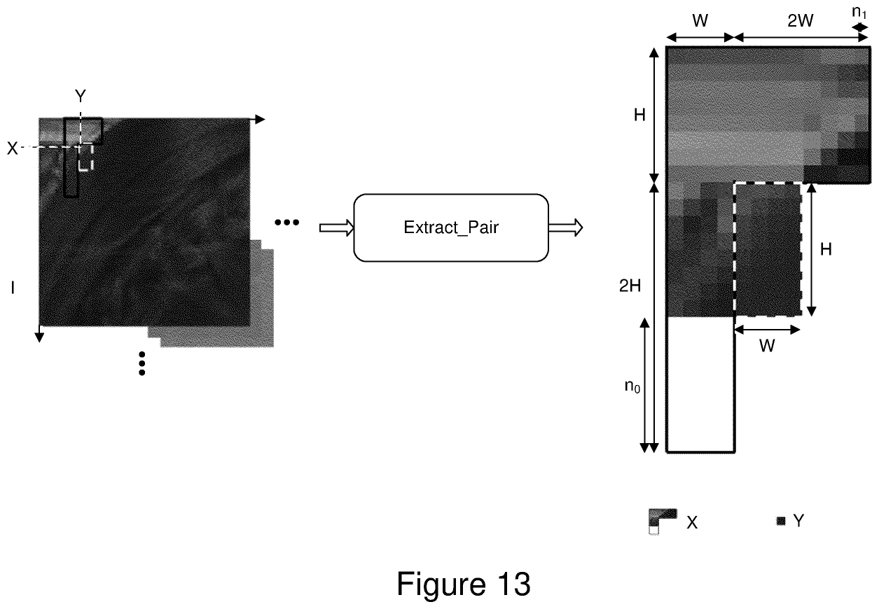

In earlier sections, for a given YC_{b}Cᵣ image I in Γ encoded via the codec of interest, yielding its reconstruction Î, the block Y is extracted from I whereas its context X is extracted from Î. Alternatively, the context can also be extracted from I. For example, in the case where the codec of interest is H.266, the current variant turns FIG. 12 into FIG. 13. FIG. 13 shows an extraction via “extract_pair” of a H×W block Y and its context X from the original image I at the spatial location x, y given by the image partitioning, H.266 being used to encode I with QP of 37. The image is in 4:2:0, H=8, W=4, x=8, y=16. Here, the n0=8 rows at the bottom-left of the block are not reconstructed yet and all the rows on the above-right side of the block are already reconstructed.

Substitution of the “Random” Data Extraction with the “Partitioning” Data Extraction at the First Iteration of the Training

In Method 1, the first step corresponds to the “partitioning” data extraction, whose principle is explained earlier. Instead, the first step can correspond to the “random” data extraction, whose procedure is detailed in an earlier section. Note that, in the latter case, at the end of the first iteration of the iterative training, the trained neural networks are extremely “generic” intra predictors. Then, from the second iteration, the trained neural networks specialize to the codec of interest.

Elimination from the Training Sets of the Blocks that are “Unpredictable” from their Context Alone Via Neural Networks

At the iteration i ε [symbol] 1, l−1 [symbol] of the iterative training, when creating the training sets

$${\{ {S}_{H , W} \}}_{H ∈ {R}_{H} , W ∈ {R}_{W}} ,$$

see Method 1, a block can be returned by the partitioning of a YC_{b}Cᵣ image via the codec of interest with the single additional neural network-based mode because a regular intra prediction mode in this codec provides a prediction of this block with relatively high prediction quality. However, this block could be “unpredictable” from its context alone via the single additional neural network-based mode. To avoid retraining a neural network using blocks that are “unpredictable” from their context alone via the previously trained model, Method 3 and Method 5 can be supplemented with a condition that detects and removes these blocks, each paired with its context. Any condition could be used.

For instance, two different conditions are explained. In the two conditions, the training sets contains luminance blocks exclusively. This implies that, in Method 2, Method 3, Method 4, and Method 5, for a given YC_{b}Cᵣ image I in Γ encoded via the codec of interest with the single additional neural network-based mode, a luminance block Y is extracted from the luminance channel of I whereas its luminance context X is extracted from the luminance channel of the reconstruction Î of I.

This first condition is separated into two cases. In the first case, a luminance block (TB) returned by the partitioning of a YC_{b}Cᵣ image does not arise from the split of its luminance PB into different luminance TBs, i.e. this TB and its PB are equivalent. The first case is indicated by the flag isSplit=false. In the second case, isSplit=true and the luminance TB comes from at least one split of this kind. If isSplit=false, we look for the t lowest “fast costs” over all the intra prediction modes on this luminance TB and the “fast cost” cₙₙ∈ [symbol] ₊* of the single additional neural network-based mode on this luminance TB. The “fast cost” of an intra prediction mode on a block linearly combines the distortion between this block and the mode prediction and an approximation of the cost of signaling this mode. In H.265, the distortion is a Sum of Absolute Difference (SAD) whereas, in H.266, it is minimum between a SAD times 2 and a Sum of Absolute Transform Difference (SATD). If cₙₙ is smaller than γ∈ [symbol] ₊* times the t^{th} lowest “fast cost” cₜ∈ [symbol] ₊* the luminance TB is added to the training set. Otherwise, it is ignored. Typically, γ∈[0.90, 1.10] works well. t can take any value smaller than the number of regular intra prediction modes in the codec of interest. For example, t∈{2, 3} works well. If isSplit=true, the luminance TB is added to the training set if the single additional neural network-based mode of index idxNN is selected for predicting this TB. For instance, in this variant, Method 5 becomes Method 6.

### Method 6: “Extract_from_Partitioning_Nn” in the Case of H.266 and the First Condition in Above Section

```
$Input : Γ and {\{ {θ}_{H , W} \}}_{H ∈ {R}_{H} , W ∈ {R}_{W}}$
  for all H ∈ R_{H}, W ∈ R_{W} do
    S_{H,W} = { }
  end for
  for all I ∈ Γ do
    QP ~ [symbol]  {22, 27, 32, 37}
    $\hat{I} , B = h266\_nn ( I , QP ; {\{ {θ}_{H , W} \}}_{H ∈ {R}_{H} , W ∈ {R}_{W}} )$
    for all (x, y, H, W, n₀, n₁, m, cₙₙ, cₜ, isSplit) ∈ B do
      isAdded = false
      if isSplit then
        if m = = idxNN then
          isAdded = true
        end if
      else
        if cₙₙ ≤ γcₜ then
          isAdded = true
        end if
      end if
      if isAdded then
        X, Y = extract_pair(I, Î, x, y, H, W, n₀, n₁)
        X_{c}, Y_{c} = preprocess(X, Y)
        S_{H,W}.append((X_{c}, Y_{c}))
      end if
    end for
  end for
$Output : {\{ {S}_{H , W} \}}_{H ∈ {R}_{H} , W ∈ {R}_{W}}$
```

In Method 6, m refers to the index of the intra prediction mode selected for predicting the current TB returned by the image partitioning.
In the second condition, the flag isSplit is no longer used, see Method 7.

### Method 7: “Extract_from_Partitioning_Nn” in the Case of H.266 and the Second Condition in Above Section

```
$Input : Γ and {\{ {θ}_{H , W} \}}_{H ∈ {R}_{H} , W ∈ {R}_{W}}$
  for all H ∈ R_{H}, W ∈ R_{W} do
    S_{H,W} = { }
  end for
  for all I ∈ Γ do
    QP ~ [symbol]  {22, 27, 32, 37}
    $\hat{I} , B = h266\_nn ( I , QP ; {\{ {θ}_{H , W} \}}_{H ∈ {R}_{H} , W ∈ {R}_{W}} )$
    for all (x, y, H, W, n₀, n₁, m) ∈ B do
      if m = = idxNN then
        X, Y = extract_pair(I, Î, x, y, H, W, n₀, n₁)
        X_{c}, Y_{c} = preprocess(X, Y)
        S_{H,W}.append((X_{c}, Y_{c}))
      end if
    end for
  end for
$Output : {\{ {S}_{H , W} \}}_{H ∈ {R}_{H} , W ∈ {R}_{W}}$
```

Replacing the “Fast Cost” with a Measure OF Distortion in an Earlier Variant

In the variant in the section “Elimination from the training sets of the blocks that are “unpredictable” from their context alone via neural networks”, each “fast-cost” of an intra prediction mode on the current luminance TB can be replaced by a distortion between the current luminance TB and the prediction provided by this mode. Any measure of distortion is valid. For instance, if the sum of squared differences between the current luminance TB and the prediction given by the mode, called “prediction SSD”, is chosen as measure of distortion, the variant is adapted as in an earlier section. If isSplit=false, we look for the t lowest prediction SSDs over all the intra prediction modes on this luminance TB and the prediction SSD dₙₙ∈ [symbol] ₊* of the single additional neural network-based mode on this luminance TB. If dₙₙ is smaller than γ times the t^{th} lowest prediction SSD dₜ∈ [symbol] ₊*, the luminance TB is added to the training set.

Otherwise, it is ignored. If isSplit=true, the luminance TB is added to the training set if the single additional neural network-based mode of index idxNN is selected for predicting this TB. For example, Method 8 replaces the “fast cost” in Method 6 by the prediction SSD as follows.

Method 8: “Extract_from_Partitioning_Nn” in the Case of H.266 when the “Fast Cost” is Replaced by the Prediction SSD

```
$Input : Γ and {\{ {θ}_{H , W} \}}_{H ∈ {R}_{H} , W ∈ {R}_{W}}$
  for all H ∈ R_{H}, W ∈ R_{W} do
    S_{H,W} = { }
  end for
  for all I ∈ Γ do
    QP ~ [symbol]  {22, 27, 32, 37}
    $\hat{I} , B = h266\_nn ( I , QP ; {\{ {θ}_{H , W} \}}_{H ∈ {R}_{H} , W ∈ {R}_{W}} )$
    for all (x, y, H, W, n₀, n₁, m, dₙₙ, dₜ, isSplit) ∈ B do
      isAdded = false
      if isSplit then
        if m = = idxNN then
          isAdded = true
        end if
      else
        if dₙₙ ≤ γdₜ then
          isAdded = true
        end if
      end if
      if isAdded then
        X, Y = extract_pair(I, Î, x, y, H, W, n₀, n₁)
        X_{c}, Y_{c} = preprocess(X, Y)
        S_{H,W}.append((X_{c}, Y_{c}))
      end if
    end for
  end for
$Output : {\{ {S}_{H , W} \}}_{H ∈ {R}_{H} , W ∈ {R}_{W}}$
```

Extracting an Equivalent Number of Training Pairs from Each YC_{B}C_{R} Image

From Method 2 to Method 8, if some images of Γ are larger than others, the training sets are filled with much more pairs of a preprocessed block and its preprocessed context extracted from the relatively large images. This implies that the variety of textures found in the training pairs is unbalanced towards those existing in the relatively large images. To bypass this, each method from Method 2 to Method 8 can be supplemented with a criterion that limits the number of training pairs extracted from each image in Γ to s∈ [symbol] *. Typically, s∈ [symbol] 20, 40 [symbol] works well when Γ contains over 1 million YC_{b}Cᵣ images. To avoid only extracting blocks located around the top-left corner of YC_{b}Cᵣ images, for each image, the s training pairs are uniformly drawn among all the training pairs extracted from this image. For instance, Method 9 supplements Method 5 with the above-mentioned criterion. Method 10 supplements Method 6 with the above-mentioned criterion.

Method 9: “Extract_from_Partitioning_Nn” in the Case of H.266, with the Criterion Detailed in Previous Section

```
$Input : Γ and {\{ {θ}_{H , W} \}}_{H ∈ {R}_{H} , W ∈ {R}_{W}}$
  for all H ∈ R_{H}, W ∈ R_{W} do
    S_{H,W} = { }
  end for
  for all I ∈ Γ do
    QP ~ [symbol]  {22, 27, 32, 37}
    $\hat{I} , B = h266\_nn ( I , QP ; {\{ {θ}_{H , W} \}}_{H ∈ {R}_{H} , W ∈ {R}_{W}} )$
    B′ = shuffle(B)
    i = 0
    for all (x, y, H, W, n₀, n₁) ∈ B′ do
      X, Y = extract_pair(I, Î, x, y, H, W, n₀, n₁), see FIG. 12.
      X_{c}, Y_{c} = preprocess(X, Y)
      S_{H,W}.append((X_{c}, Y_{c}))
      i += 1
      if i = = s then
        break
      end if
    end for
  end for
$Output : {\{ {S}_{H , W} \}}_{H ∈ {R}_{H} , W ∈ {R}_{W}}$
```

Method 10: “Extract_from_Partitioning_Nn” in the Case of H.266 and the First Condition in the Section “Elimination from the Training Sets of the Blocks that are “Unpredictable” from their Context Alone Via Neural Networks”, with the Criterion Detailed in the Previous Paragraph

```
$Input : Γ and {\{ {θ}_{H , W} \}}_{H ∈ {R}_{H} , W ∈ {R}_{W}}$
  for all H ∈ R_{H}, W ∈ R_{W} do
    S_{H,W} = { }
  end for
  for all I ∈ Γ do
    QP ~ [symbol]  {22, 27, 32, 37}
    $\hat{I} , B = h266\_nn ( I , QP ; {\{ {θ}_{H , W} \}}_{H ∈ {R}_{H} , W ∈ {R}_{W}} )$
    B′ = shuffle(B)
    i = 0
    for all (x, y, H, W, n₀, n₁, m, cₙₙ, cₜ, isSplit) ∈ B′ do
      isAdded = false
      if isSplit then
        if m = = idxNN then
          isAdded = true
        end if
      else
        if cₙₙ ≤ γcₜ then
          isAdded = true
        end if
      end if
      if isAdded then
        X, Y = extract_pair(I, Î, x, y, H, W, n₀, n₁)
        X_{c}, Y_{c} = preprocess(X, Y)
        S_{H,W}.append((X_{c}, Y_{c}))
        i += 1
      end if
      if i = = s then
        break
      end if
    end for
  end for
$Output : {\{ {S}_{H , W} \}}_{H ∈ {R}_{H} , W ∈ {R}_{W}}$
```

In Method 9 and Method 10, the function “shuffle” shuffles the elements of its input set. An element of B gathers the characteristics of a block returned by the image partitioning. Moreover, the “break” statement breaks out of the innermost enclosing “for” loop, as in C.

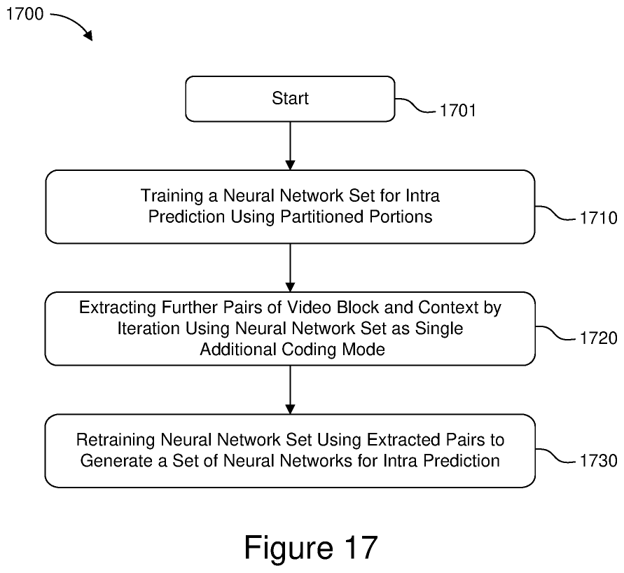

One embodiment of a method 1700 under the described aspects is shown in FIG. 17. The method commences at Start block 1701 and commences to block 1710 for training a set of neural networks for intra prediction of a video block using pairs of partitioned portions of the video block and surrounding regions. The method proceeds from block 1710 to block 1720 for extracting further pairs of the video block and surrounding regions by iteratively using the set of neural networks as a single additional intra coding mode for a codec. Control proceeds from block 1720 to block 1730 for retraining the set of neural networks using the extracted further pairs to generate a set of neural networks for intra prediction.

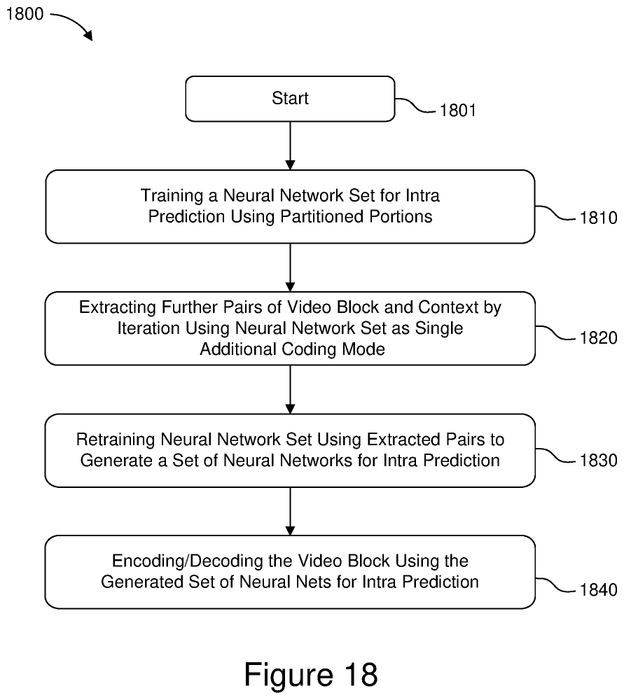

Another embodiment of a method 1800 under the described aspects is shown in FIG. 18. The method commences at Start block 1801 and commences to block 1810 for training a set of neural networks for intra prediction of a video block using pairs of partitioned portions of the video block and surrounding regions. The method proceeds from block 1810 to block 1820 for extracting further pairs of the video block and surrounding regions by iteratively using the set of neural networks as a single additional intra coding mode for a codec. Control proceeds from block 1820 to block 1830 for retraining the set of neural networks using the extracted further pairs to generate a set of neural networks for intra prediction. Control proceeds from block 1830 to block 1840 for Encoding/Decoding the video block using the generated set of neural nets for intra prediction

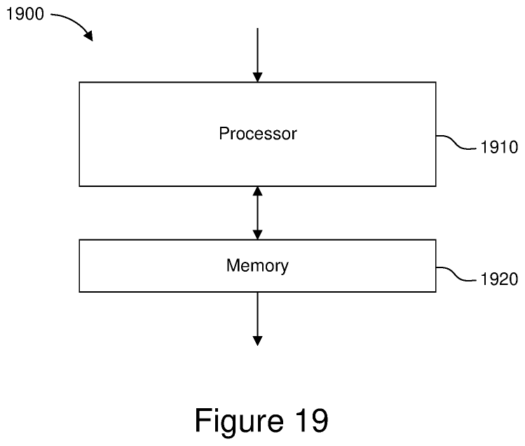

FIG. 19 shows one embodiment of an apparatus 1900 for encoding, decoding, compressing or decompressing video data using simplifications of coding modes based on neighboring samples dependent parametric models. The apparatus comprises Processor 1910 and can be interconnected to a memory 1920 through at least one port. Both Processor 1910 and memory 1920 can also have one or more additional interconnections to external connections.

Processor 1910 is also configured to either insert or receive information in a bitstream and, either compressing, encoding or decoding using any of the described aspects.

This document describes a variety of aspects, including tools, features, embodiments, models, approaches, etc. Many of these aspects are described with specificity and, at least to show the individual characteristics, are often described in a manner that can sound limiting. However, this is for purposes of clarity in description, and does not limit the application or scope of those aspects. Indeed, all the different aspects can be combined and interchanged to provide further aspects. Moreover, the aspects can be combined and interchanged with aspects described in earlier filings as well.

The aspects described and contemplated in this document can be implemented in many different forms. FIGS. 12, 13, and 14 below provide some embodiments, but other embodiments are contemplated and the discussion of FIGS. 12, 13, and 14 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined.

Various methods and other aspects described in this document can be used to modify modules, for example, the intra prediction, entropy coding, and/or decoding modules (160, 360, 145, 330), of a video encoder 100 and decoder 200 as shown in FIG. 12 and FIG. 13. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this document can be used individually or in combination.

Various numeric values are used in the present document, for example, {{1,0}, {3,1}, {1,1}}. The specific values are for example purposes and the aspects described are not limited to these specific values.

FIG. 12 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 13 illustrates a block diagram of a video decoder 200. In the decoder 200, a bitstream is decoded by the decoder elements as described below. Video decoder 200 generally performs a decoding pass reciprocal to the encoding pass as described FIG. 12. The encoder 100 also generally performs video decoding as part of encoding video data.

The input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

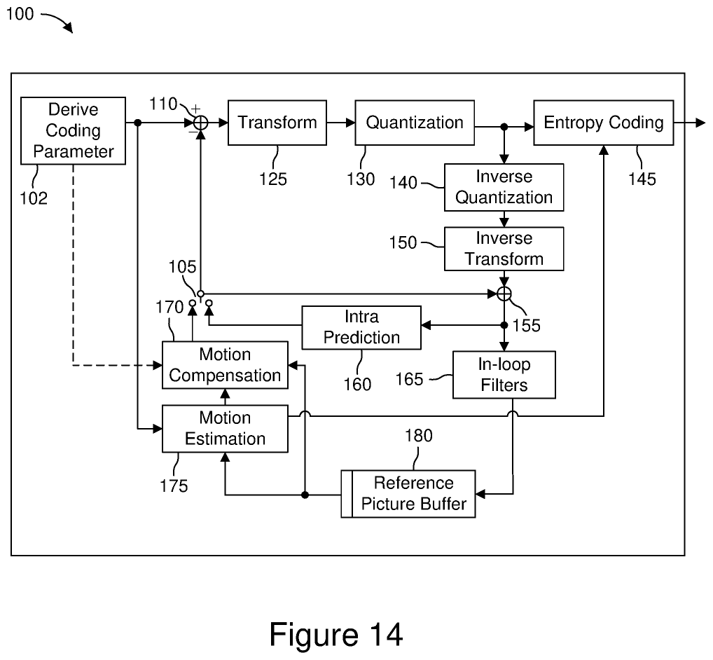

FIG. 14 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit, multiple ICs, and/or discrete components. For example, in at least one embodiment, the processing and encoder/decoder elements of system 1000 are distributed across multiple ICs and/or discrete components. In various embodiments, the system 1000 is communicatively coupled to other similar systems, or to other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, EEPROM, ROM, PROM, RAM, DRAM, SRAM, flash, magnetic disk drive, and/or optical disk drive. The storage device 1040 can include an internal storage device, an attached storage device, and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In several embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of a television. In at least one embodiment, a fast, external dynamic volatile memory such as a RAM is used as working memory for video coding and decoding operations, such as for MPEG-2, HEVC, or VVC (Versatile Video Coding).

The input to the elements of system 1000 can be provided through various input devices as indicated in block 1130. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 1130 have associated respective input processing elements as known in the art. For example, the RF portion can be associated with elements necessary for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the I2C bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed to the system 1000, in various embodiments, using a wireless network, such as IEEE 802.11. The wireless signal of these embodiments is received over the communications channel 1060 and the communications interface 1050 which are adapted for Wi-Fi communications, for example. The communications channel 1060 of these embodiments is typically connected to an access point or router that provides access to outside networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130.

The system 1000 can provide an output signal to various output devices, including a display 1100, speakers 1110, and other peripheral devices 1120. The other peripheral devices 1120 include, in various examples of embodiments, one or more of a stand-alone DVR, a disk player, a stereo system, a lighting system, and other devices that provide a function based on the output of the system 1000. In various embodiments, control signals are communicated between the system 1000 and the display 1100, speakers 1110, or other peripheral devices 1120 using signaling such as AV.Link, CEC, or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device, for example, a television. In various embodiments, the display interface 1070 includes a display driver, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, extracting an index of weights to be used for the various intra prediction reference arrays.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, weighting of intra prediction reference arrays.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion calculation or rate distortion optimization. During the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this document are not necessarily all referring to the same embodiment.

Additionally, this document may refer to “determining” various pieces of information. Determining the information can include one or more of, for example, estimating the information, calculating the information, predicting the information, or retrieving the information from memory.

Further, this document may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this document may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of weights to be used for intra prediction reference arrays. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Embodiments may include one or more of the following features or entities, alone or in combination, across various different claim categories and types:
Using a set of neural networks as additional prediction mode(s) in a codec, the modes can be intra prediction modes and the neural networks can be of various sizes.
Using a single additional intra prediction mode comprised of neural networks of varying sizes.
Using a single additional intra prediction mode comprised of neural networks of varying sizes wherein a codec with the single additional intra prediction mode is used to build initial training sets for the neural network set and the neural networks comprising the set are retrained with the initial training sets.
The above single intra prediction mode where a neural network corresponding to one of the sizes is trained via random data extraction.
Using a set of neural networks as additional intra prediction mode in an H.265 codec, the modes can be intra prediction modes and the neural networks can be of various sizes.
Training of the above set of neural networks as an additional intra prediction mode in an H.265 codec, wherein for each block a set of characteristics from a partitioned block are used to extract the block and its context from an image and the characteristics and its context are preprocessed to yield a training pair to be added to the training set.
Training at least one neural network for intra prediction wherein the neural networks learn an intra prediction diverging from that in a codec while still being valuable for that codec in terms of rate-distortion performance.
Encoding/decoding a set of images using a codec to yield training sets containing pairs of blocks with size provided by partitioning of at least one of the images and its context and using the training sets for training corresponding neural networks.
The above encoding/decoding where blocks are rectangular.
A bitstream or signal that includes one or more of the described syntax elements, or variations thereof.
Creating and/or transmitting and/or receiving and/or decoding a bitstream or signal that includes one or more of the described syntax elements, or variations thereof.
A TV, set-top box, cell phone, tablet, or other electronic device that performs in-loop filtering according to any of the embodiments described.
A TV, set-top box, cell phone, tablet, or other electronic device that performs in-loop filtering according to any of the embodiments described, and that displays (e.g. using a monitor, screen, or other type of display) a resulting image.
A TV, set-top box, cell phone, tablet, or other electronic device that tunes (e.g. using a tuner) a channel to receive a signal including an encoded image, and performs in-loop filtering according to any of the embodiments described.
A TV, set-top box, cell phone, tablet, or other electronic device that receives (e.g. using an antenna) a signal over the air that includes an encoded image, and performs in-loop filtering according to any of the embodiments described.
   Various other generalized, as well as particularized, inventions and claims are also supported and contemplated throughout this description.

1. A method, comprising:
training a set of neural networks for intra prediction of a video block using pairs of partitioned portions of said video block and surrounding regions;
extracting further pairs of said video block and surrounding regions by iteratively using said set of neural networks as an additional intra coding mode for a codec; and,
retraining said set of neural networks using said extracted further pairs to generate a set of neural networks for intra prediction.

2. An apparatus, comprising:
a processor, configured to:
train a set of neural networks for intra prediction of a video block using pairs of partitioned portions of said video block and surrounding regions;
extract further pairs of said video block and surrounding regions by iteratively using said set of neural networks as an additional intra coding mode for a codec; and,
retrain said set of neural networks using said extracted further pairs to generate a set of neural networks for intra prediction.

3. The method of claim 1, further comprising:
encoding a video block using intra prediction with said retrained set of neural networks.

4. The method of claim 1, further comprising:
decoding a video block using intra prediction with said retrained set of neural networks.

5. The apparatus of claim 2, further configured to:
encode a video block using intra prediction with said retrained set of neural networks.

6. The apparatus of claim 2, further configured to:
decode a video block using intra prediction with said retrained set of neural networks.

7. The method of claim 1, wherein the partitioned portions are rectangular.

8. The method of claim 1, wherein block height is added to characteristics of said video block.

9. The method of claim 1, wherein characteristics are used to extract a block from its reconstruction.

10. The method of claim 9 wherein a set B of characteristics of blocks results from said partitioning.

11. The method of claim 1, wherein a number of pairs of partitioned portions extracted is limited.

12. A device comprising:
an apparatus according to claim 2, and
at least one of (i) an antenna configured to receive a signal, the signal including the video block, (ii) a band limiter configured to limit the received signal to a band of frequencies that includes the video block, and (iii) a display configured to display an output representative of a video block.

13. A non-transitory computer readable medium containing data content generated according to the method of claim 1, for playback using a processor.

14. A non-transitory computer readable medium containing data content comprising instructions to enable a processor to perform the method of claim 1.

15. A non-transitory computer program product comprising instructions which, when the program is executed by a computer, cause the computer to carry out the method of any one of claim 2.

16. The apparatus of claim 2, wherein the partitioned portions are rectangular.

17. The apparatus of claim 2, wherein block height is added to characteristics of said video block.

18. The apparatus of claim 2, wherein characteristics are used to extract a block from it reconstruction.

19. The apparatus of claim 18, wherein a set B of characteristics of blocks results from said partitioning.

20. The apparatus of claim 2, wherein a number of pairs of partitioned portions extracted is limited.
